(19) United States
(12) Patent Application Publication
(10) Pub. No.: US 2010/0186530 A1
(43) Pub. Date: Jul. 29, 2010

(54) SHIFT CONTROL DEVICE FOR AUTOMATIC TRANSMISSION

(75) Inventors: MASAYA TAMAI, Wako-shi (JP); NORIYUKI YAGI, Wako-shi (JP); AKIHIRO UEKI, Wako-shi (JP); AKIRA YOSHIDA, Wako-shi (JP); YUJI OKAZAKI, Wako-shi (JP); YOSHIFUMI MURAKAMI, Wako-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/688,336

(22) Filed: Jan. 15, 2010

(30) Foreign Application Priority Data
Jan. 23, 2009 (JP) 2009-013675

(51) Int. Cl. F16H 59/02

(52) U.S. Cl. 74/473.11

(57) ABSTRACT

Lubricating oil passages extending toward a power transmission mechanism from a regulator valve to lubricate the power transmission mechanism include a first lubricating oil passage for supplying lubricating oil to a low clutch used to set up a low gear speed and a second lubricating oil passage for supplying lubricating oil with line pressure to the low clutch. A check valve for preventing the lubricating oil from flowing out from frictional engagement elements other than the low clutch when the second lubricating oil passage is selected, is provided on the first lubricating oil passage. An outflow preventing section for preventing the lubricating oil, supplied to the low clutch via the first lubricating oil passage, from flowing out from any open port of hydraulic control valves when the second lubricating oil passage is not selected, is provided on the second lubricating oil passage.

### CROSS-REFERENCE TO RELATED APPLICATION

The present disclosure relates to subject matter contained in Japanese Patent Application No. 2009-013675, filed on Jan. 23, 2009, the disclosure of which is expressly incorporated herein by reference in its entirety.

### BACKGROUND OF THE INVENTION

1. Field of the Invention

The present invention relates to a shift control device for an automatic transmission that carries out switching setup of a reverse range, a neutral range and a forward range by means of a shift control valve provided with a manual valve and the like operated in accordance with manipulation of a shift lever by a driver and carries out automatic shift control at the reverse and forward ranges, and particularly, the present invention relates to a shift control device for an automatic transmission capable of supplying lubricating oil with line pressure to a low clutch at neutral idle control of the automatic transmission.

2. Description of the Related Art

Heretofore, in order to heighten fuel economy (gasoline mileage) of a vehicle provided with an automatic transmission, a hydraulic control device for an automatic transmission, which increases line pressure of a hydraulic circuit on the basis of a load when the load is applied to the line pressure while stopping a vehicle, is known (for example, see Japanese Patent Application Publication No. 60-69356, hereinafter, referred to as “Patent Literature 1”). In the vehicle provided with this automatic transmission, it is possible to prevent a wasteful fuel from being consumed due to a so-called creep phenomenon while stopping the vehicle, in particular.

In a creep phenomenon preventive device for a vehicle provided with an automatic transmission disclosed in Patent Literature 1, surplus oil of hydraulic oil discharged by a hydraulic pump (oil pump) is introduced to a lubricating oil passage by means of a regulator valve to be fed to lubricating portions of the respective portions. Here, in order to ensure minimal hydraulic pressure required for lubrication, a control valve (regulator valve) is connected to the lubricating oil passage.

Further, an assignee of the present application has proposed a shift control device for an automatic transmission capable of setting up a number of shift patterns using On/Off solenoid valves fewer than the number of shift patterns (for example, see Japanese Patent Application Publication No. 2006-336817, hereinafter, referred to as “Patent Literature 2”). In the shift control device for the automatic transmission disclosed in Patent Literature 2, shift control for a five-gear-speed automatic transmission is made using four On/Off solenoid valves and two cut valves. By reducing the number of On/Off solenoid valves in this manner, it is possible to reduce production costs of the shift control device for the automatic transmission.

However, in hydraulic control of general multi-gear-speed automatic transmissions including those disclosed in Patent Literature 1 and Patent Literature 2, the hydraulic oil discharged from the hydraulic pump is preferentially supplied as fluid for engagement of clutches, control of shift hydraulic pressure and control of a torque converter. Open/Close of the regulator valve causes surplus oil of the hydraulic oil to flow into a lubricating oil passage, thereby ensuring lubrication of the clutches (frictional engagement elements), gears and bearings.

Here, the hydraulic pump has pump characteristics in which the amount of discharge is changed in accordance with the number of revolutions of an engine. For this reason, at a state where the number of revolutions of the engine is low (small), for example, at idling of the engine, the regulator valve is not opened, whereby it is hardly possible to ensure lubrication of the clutches and the like. In particular, at neutral idle control in which the automatic transmission is controlled so as to become a pseudo neutral state under a predetermined condition when a shift position is set to a forward (drive) range (D position), drag of a low clutch tends to cause heat to be generated. Therefore, a problem appears that the low clutch is burned out if sufficient lubrication is not obtained.

Further, in order to solve the problem that the amount of lubricating oil is to be lowered as described above and to ensure the amount of lubricating oil for the clutches (in particular, the low clutch), it is thought that a bypass oil passage from a line pressure oil passage to a lubricating oil passage is provided, and hydraulic oil with line pressure is caused to flow into the lubricating oil passage through an orifice with a minor diameter, provided in this bypass oil passage, for example. However, in such a case, since the automatic transmission is in a state where flow of the hydraulic oil into the lubricating oil passage through the orifice with the minor diameter is always carried out, the amount of lubricating oil is too much at a normal drive mode. Therefore, there is also a problem that this negatively affects friction and the like of the automatic transmission.

### SUMMARY OF THE INVENTION

The present invention is made in view of the above points, and it is an object of the present invention to provide a shift control device for an automatic transmission capable of sufficiently ensuring the amount of clutch lubricating oil if needed, that is, at idling of an engine at which the amount of lubricating oil to a lubricating oil passage is generally lowered (in particular, at neutral idle control) by a small change (or modification) of a hydraulic circuit in the shift control device for the automatic transmission that can set up a lot of shift patterns using a few On/Off solenoid valves, for example.

In order to solve the problem described above, the present invention is directed to a shift control device for an automatic transmission (TM). The shift control device for the automatic transmission (TM) according to the present invention includes a power transmission mechanism (TMM) for carrying out transmission of drive power, the power transmission mechanism (TMM) having a plurality of power transmission routes.

The shift control device for the automatic transmission (TM) also includes a plurality of frictional engagement elements (11 to 15) for selecting anyone of the power transmission routes, any one of the plurality of frictional engagement elements (11 to 15) being selected and operated to set up a desired gear from a plurality of gears.

The shift control device for the automatic transmission (TM) also includes a hydraulic supply source (OP).

The shift control device for the automatic transmission (TM) also includes a regulator valve (50) for regulating line pressure (PL) on the basis of hydraulic pressure supplied from the hydraulic supply source (OP), the line pressure (PL) becoming basis pressure for operating the frictional engagement elements (11 to 15).

The shift control device for the automatic transmission (TM) also includes a group of hydraulic control valves (61 to 65, 81 to 84, 86 to 88, 91, 92 and the like) for carrying out supply control of engagement control hydraulic pressure to the frictional engagement elements (11 to 15), the group of hydraulic control valves including a plurality of linear solenoid valves (86 to 88) capable of arbitrarily regulating shift control hydraulic pressure, a plurality of shift valves (61 to 64) and a plurality of cut valves (91, 92) for carrying out selection of an oil passage so as to selectively supply the line pressure (PL) or the shift control hydraulic pressure regulated by any of the linear solenoid valves (86 to 88) to the frictional engagement elements (11 to 15), and a plurality of On/Off solenoid valves (81 to 84) for supplying operation control hydraulic pressure to the shift valves (61 to 64) to control operations thereof.

The shift control device for the automatic transmission (TM) also includes hydraulic oil passages including a first hydraulic oil passage for supplying the shift control hydraulic pressure, supplied from a linear solenoid valve (86) for setting up a low gear speed of the plurality of linear solenoid valves (86 to 88), to a low clutch (11) that is one of the frictional engagement elements (11 to 15) and a second hydraulic oil passage for supplying the line pressure (PL) regulated by the regulator valve (50) to the low clutch (11), the first hydraulic oil passage and the second hydraulic oil passage being switched in accordance with an operation state and a set state of a predetermined shift valve (62) of the plurality of shift valves (61 to 64), selection of the hydraulic oil passage being carried out by controlling operations of the plurality of shift valves (61 to 64) in accordance with combination of On/Off operations of the plurality of On/Off solenoid valves (81 to 84), the same On/Off operation combination pattern of the plurality of On/Off solenoid valves (81 to 84) being set up in each of an operation state and a set state of the plurality of cut valves (91, 92) to set up different gears.

The shift control device for the automatic transmission (TM) also includes lubricating oil passages (oil passage for supplying lubricating oil to the respective portions via an oil passage 192) extending toward the power transmission mechanism (TMM) from the regulator valve (50) to lubricate the power transmission mechanism (TMM), the lubricating oil passages including a first lubricating oil passage for supplying lubricating oil to the low clutch (11) used to set up the low gear speed and a second lubricating oil passage for supplying lubricating oil with the line pressure (PL) to the low clutch (11), the second lubricating oil passage being selected by setting up the predetermined shift valve (62) to the set state under a predetermined condition.

The shift control device for the automatic transmission (TM) also includes a check valve (300) provided on the first lubricating oil passage, the check valve (300) preventing the lubricating oil from flowing out from the frictional engagement elements (12 to 15) other than the low clutch (11) when the second lubricating oil passage is selected.

The shift control device for the automatic transmission (TM) also includes an outflow preventing section (200, 201) provided on the second lubricating oil passage, the outflow preventing section (200, 201) preventing the lubricating oil, supplied to the low clutch (11) via the first lubricating oil passage, from flowing out from any open port of the group of hydraulic control valves (61 to 65, 81 to 84, 86 to 88, 91, 92 and the like) when the second lubricating oil passage is not selected.

According to the shift control device for the automatic transmission of the present invention, by setting up the predetermined shift valve to the set state to select the second lubricating oil passage under the predetermined condition (for example, an engine idling state such as during pseudo neutral control (will be described later)), it is possible to supply the sufficient amount of lubricating oil with line pressure to the low clutch in a situation in which temperature around the low clutch rises. This makes it possible to effectively prevent burn-in (or burnout) of the low clutch due to drag of the low clutch at pseudo neutral control, in particular. Further, in the case where the amount of lubricating oil for the low clutch is enough, the predetermined shift valve is set to the operation state to stop supplying the lubricating oil with the line pressure. Therefore, it is possible to prevent friction of the low clutch from deteriorating due to increase in the amount of lubricating oil in such a case.

In the shift control device for the automatic transmission according to the present invention, it is preferable that the second lubricating oil passage is branched from the second hydraulic oil passage by the predetermined shift valve (62). Thus, by adding a minimal configuration (for example, a configuration to connect a line of a second lubricating oil passage to the low clutch to a spool channel for switching the second hydraulic oil passage in the predetermined shift valve) to an existing hydraulic circuit, it is possible to increase the amount of lubricating oil to be supplied to the low clutch if needed.

In the shift control device for the automatic transmission according to the present invention, it is preferable that the outflow preventing section is a check valve (200) for preventing the lubricating oil from flowing out or a lubricating oil switching valve (201) for switching whether or not the lubricating oil is to be supplied, and the lubricating oil with the line pressure (PL) is supplied to the low clutch (11) via the second lubricating oil passage by setting up the lubricating oil switching valve (201) to a predetermined state in the case where the predetermined condition is met at pseudo neutral control to set the automatic transmission (TM) to a pseudo neutral state even when a shift range of the automatic transmission (TM) is set to a drive range. This makes it possible to ensure the sufficient amount of lubricating oil during pseudo neutral control (neutral idle control) under which temperature around the low clutch rises due to drag of the low clutch, in particular.

In the shift control device for the automatic transmission according to the present invention, it is preferable that the second lubricating oil passage is directly connected from the hydraulic supply source (OP) to the low clutch (11) via a predetermined group of valves (for example, 61, 91 and the like) including the predetermined shift valve (61). Thus, even though the shift control device for the automatic transmission includes a hydraulic circuit in which lubricating oil is supplied via one or more valve other than the predetermined shift valve, it is possible to effectively prevent burnout of the low clutch so long as the second lubricating oil passage can be selected by switching the predetermined shift valve between a set state and an operation state. Therefore, the present invention can be applied to an automatic transmission mounted on an existing vehicle by adding a port of a valve and another oil passage to a hydraulic circuit thereof if needed.

In this regard, reference numerals in parenthesis described above exemplify, for reference, corresponding components of embodiments (will be described later).

According to the present invention, by addition of a simple configuration (for example, addition of a port to the shift valve or the like), it is possible to supply the sufficient amount of lubricating oil with line pressure to the low clutch in a situation in which temperature around the low clutch rises. This makes it possible to effectively prevent burn-in (or burnout) of the low clutch due to drag of the low clutch at pseudo neutral control, in particular. Further, when the amount of lubricating oil for the low clutch is enough, it is possible to prevent deterioration of friction of the low clutch due to increase in the amount of lubricating oil by stopping supply of the lubricating oil with the line pressure.

### BRIEF DESCRIPTION OF THE DRAWINGS

The foregoing and other objects, features and advantages of the present invention will become more readily apparent from the following detailed description of preferred embodiments of the present invention that proceeds with reference to the appending drawings:

FIG. 1 is a schematic block diagram showing the whole configuration of a shift control device according to the present invention and an automatic transmission controlled by the shift control device;

FIG. 2 is a skeleton diagram showing a power transmission system of a five-gear-speed automatic transmission whose shift is controlled by the shift control device according to the present invention;

FIGS. 3A-3D are a hydraulic circuit diagram showing the whole configuration of the shift control device for the five-gear-speed automatic transmission described above;

FIG. 4 is a drawing showing a relation between respective shift modes and operation states of first to fourth On/Off solenoid valves, first and second cut valves and first to third linear solenoid valve;

FIG. 5 is a part of a schematic hydraulic circuit diagram according to a first embodiment of the present invention;

FIG. 6 is a graph showing a relation between the number of revolutions of an engine and the amount of lubricating oil for a low clutch;

FIG. 7 is a part of a schematic hydraulic circuit diagram according to a second embodiment of the present invention; and

FIG. 8 is a part of a schematic hydraulic circuit diagram according to a third embodiment of the present invention.

### DETAILED DESCRIPTION OF THE INVENTION

Hereinafter, embodiments of a shift control device for an automatic transmission according to the present invention will be described with reference to the appending drawings.

### First Embodiment

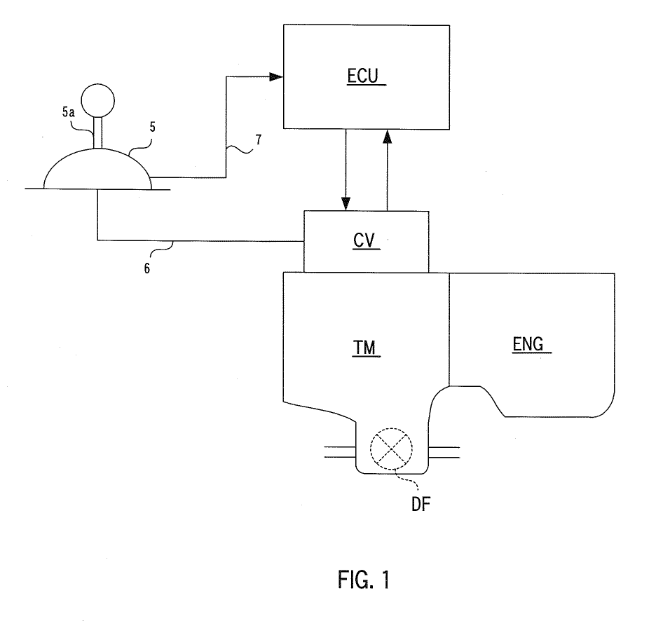

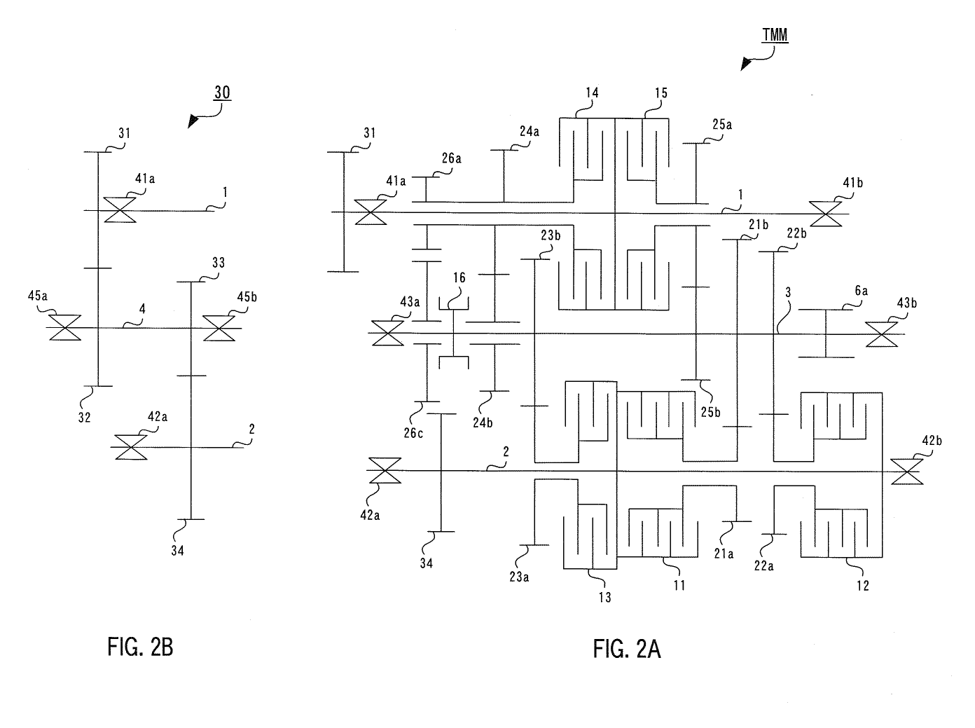

A shift control device for an automatic transmission according to a first embodiment of the present invention will now be described in detail with reference to FIG. 1 to FIG. 6. The whole configuration of an automatic transmission according to the first embodiment of the present invention will first be described. FIG. 1 is a schematic block diagram showing the whole configuration of the shift control device according to the first embodiment of the present invention and the automatic transmission controlled by the shift control device. FIG. 2 is a skeleton diagram showing a power transmission system of a five-gear-speed automatic transmission whose shift is controlled by the shift control device according to the present invention.

In the present embodiment, a power transmission mechanism TMM is configured by an automatic transmission TM that changes an output of an engine ENG to transmit the changed output to drive wheels (not shown in the drawings). Shift control of this automatic transmission TM is carried out by means of hydraulic control by a shift control valve CV. An operation of the shift control valve CV is carried out by operating a plurality of On/Off solenoid valves (will be described later) in accordance with shift control signals from an electronic control unit ECU.

As shown in FIG. 1, the electronic control unit ECU is connected to a shift operating device 5 via a signal line 7, and receives a shift position signal of a shift lever 5a from the shift operating device 5. Further, the shift lever 5a is connected to a manual valve (will be described later) in the shift control valve CV via a cable 6, and moves a spool of the manual valve in accordance with manipulation of the shift lever 5a by a driver (user). In this regard, an internal configuration of the shift control valve CV will be described later.

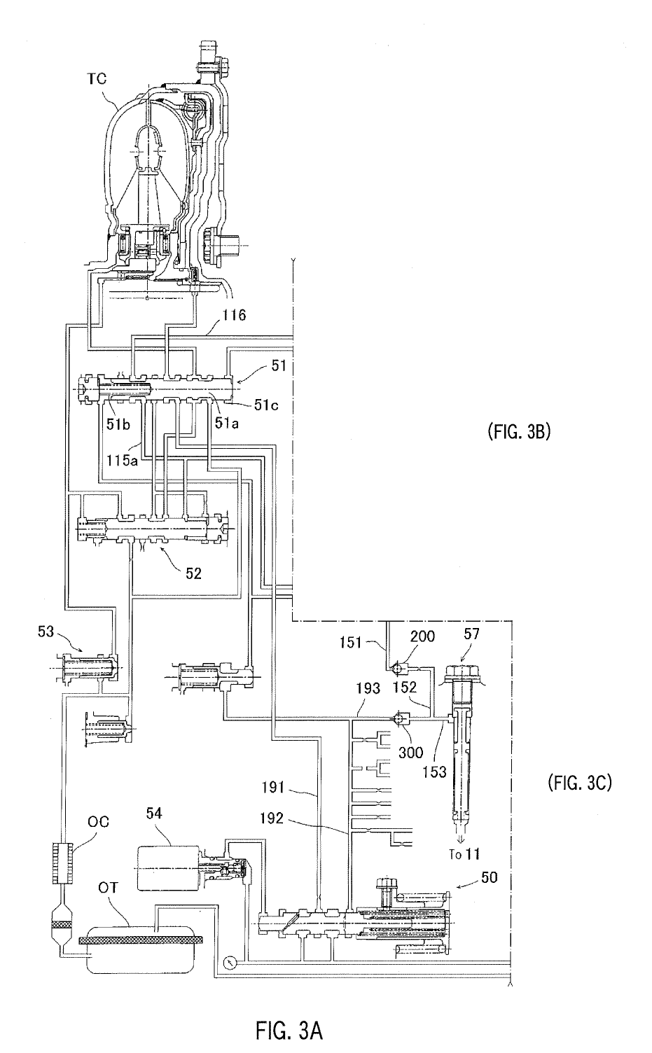

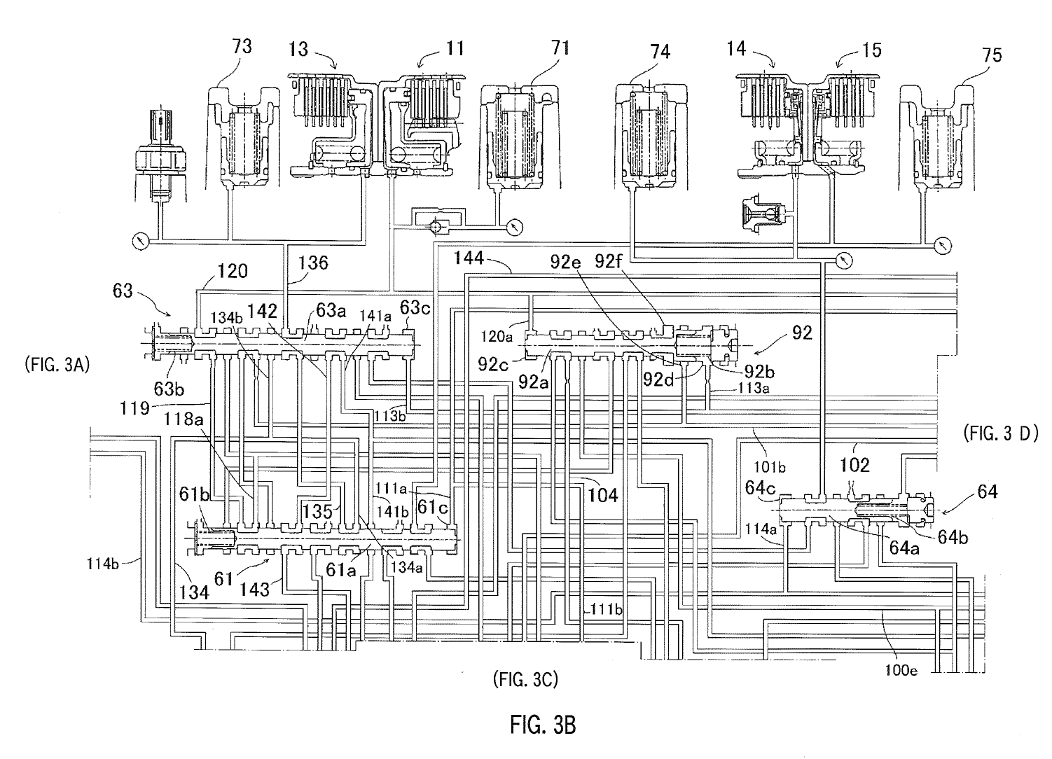

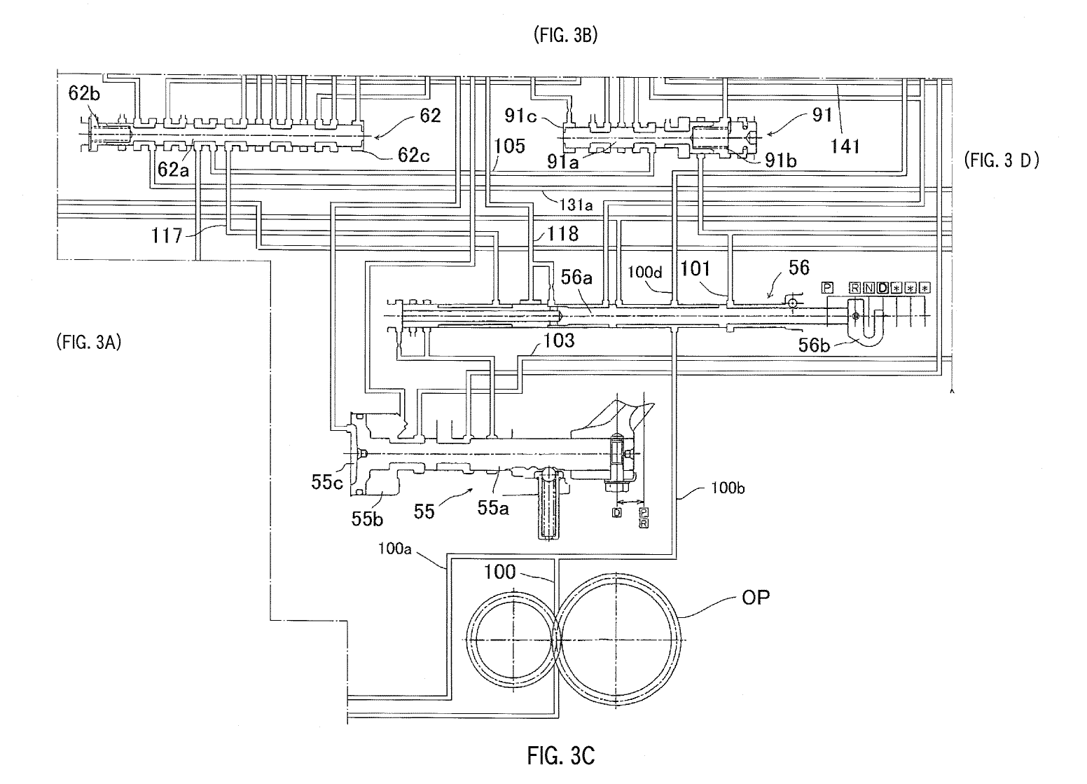

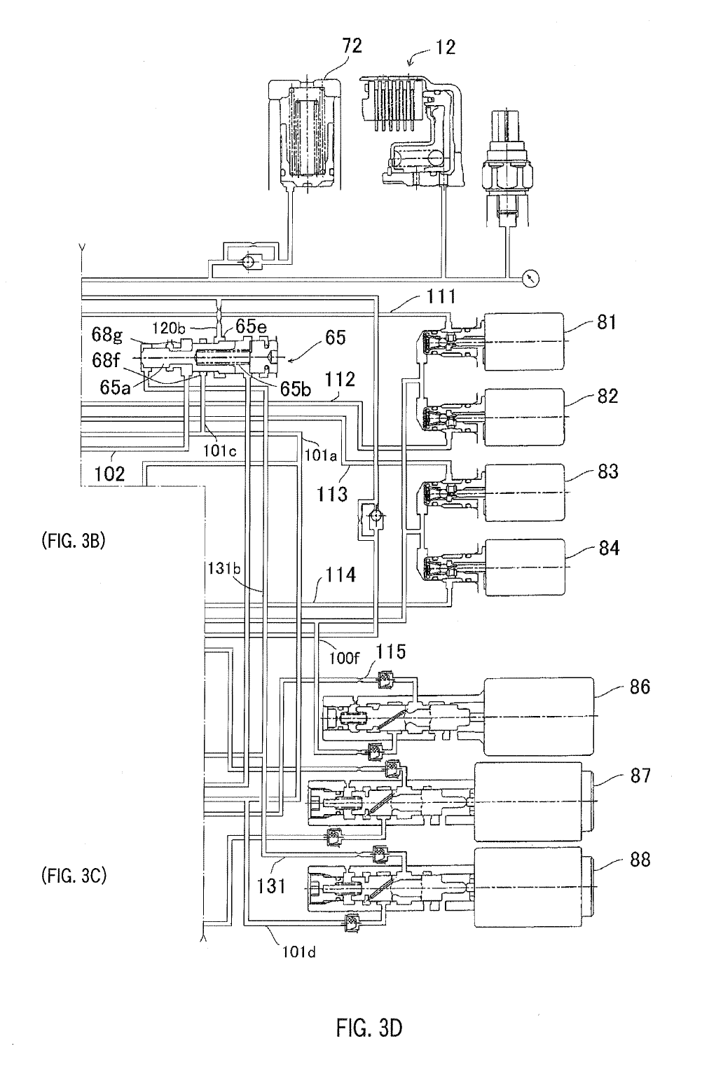

This automatic transmission TM is configured so as to arrange, in a transmission housing (not shown in the drawings), a torque converter TC (see FIG. 3A) connected to an output shaft of the engine ENG (not shown in FIGS. 3A-3D), a parallel-axes shift mechanism TMM (see FIG. 2) connected to an output member (turbine) of the torque converter TC, and a differential mechanism DF with a final reduction driven gear (not shown in the drawings) that engages with a final reduction drive gear (not shown in the drawings) of this shift mechanism TMM. The differential mechanism DF transmits driving force from the engine ENG to right and left drive wheels.

The parallel-axes shift mechanism TMM is configured so as to have a first input shaft 1, a second input shaft 2, a counter shaft 3 and an idle shaft 4, which extend in parallel to each other, as shown in FIG. 2. FIG. 2A and FIG. 2B show a configuration of power transmission of this parallel-axes shift mechanism TMM.

The first input shaft 1 is connected to the turbine (not shown in the drawings) of the torque converter TC, and is rotatably supported by means of bearings 41a, 41b. This first input shaft 1 receives driving force from the turbine of the torque converter TC to be rotated in synchronization with this turbine. On the first input shaft 1, a fifth drive gear 25a, a fifth clutch 15, a fourth clutch 14, a fourth drive gear 24a, a reverse drive gear 26a and a first connecting gear 31 are provided in this order from a side of the torque converter TC (right side in FIG. 2). The fifth drive gear 25a is rotatably provided on the first input shaft 1, and is caused to engage with or be released from the first input shaft 1 by means of the fifth clutch 15 operated on the basis of hydraulic pressure supplied from a hydraulic circuit (will be described later). The fourth drive gear 24a and the reverse drive gear 26a are integrally connected to each other, and are rotatably provided on the first input shaft 1. The fourth drive gear 24a and the reverse drive gear 26a are caused to engage with or be released from the first input shaft 1 by means of the fourth clutch 14 operated by the hydraulic circuit. The first connecting gear 31 is provided outside the bearing 41a that rotatably supports the first input shaft 1, and is directly connected to the first input shaft 1 at a cantilever state.

The second input shaft 2 is rotatably supported by means of bearings 42a, 42b. On the second input shaft 2, a second clutch 12, a second drive gear 22a, a low drive gear 21a, a low clutch 11, a third clutch 13, a third drive gear 23a and a fourth connecting gear 34 are provided in this order from the right side in FIG. 2. Each of the second drive gear 22a, the low drive gear 21a and the third drive gear 23a is rotatably provided on the second input shaft 2, and they are respectively caused to engage with or be released from the second input shaft 2 by means of the second clutch 12, the low clutch 11 and the third clutch 13 operated by the hydraulic circuit. Further, the fourth connecting gear 34 is directly connected to the second input shaft 2.

The counter shaft 3 is rotatably supported by means of bearing 43a, 43b. On the counter shaft 3, a final reduction drive gear 6a, a second driven gear 22b, a low driven gear 21b, a fifth driven gear 25b, a third driven gear 23b, a fourth driven gear 24b, a dog tooth clutch 16 and a reverse driven gear 26c are provided in this order from the right side in FIG. 2. Each of the final reduction drive gear 6a, the second driven gear 22b, the low driven gear 21b, the fifth driven gear 25b and the third driven gear 23b is directly connected to the counter shaft 3 to be rotated together with the counter shaft 3. The fourth driven gear 24b is rotatably provided on the counter shaft 3. Similarly, the reverse driven gear 26c is also provided rotatably on the counter shaft 3. The dog tooth clutch 16 is operated in an axial direction, and causes the fourth driven gear 24b to engage with or be released from the counter shaft 3, or causes the reverse driven gear 26c to engage with or be released from the counter shaft 3.

The idle shaft 4 is rotatably supported by means of bearings 45a, 45b. A second connecting gear 32 and a third connecting gear 33 are provided integrally with the idle shaft 4. The second connecting gear 32 engages with the first connecting gear 31, while the third connecting gear 33 engages with the fourth connecting gear 34. A connecting gear train 30 is constructed from these first to fourth connecting gears 31 to 34, and rotation of the first input shaft 1 is always transmitted to the second input shaft 2 via the connecting gear train 30.

In this regard, as can be seen from FIG. 2, the low drive gear 21a engages with the low driven gear 21b; the second drive gear 22a engages with the second driven gear 22b; the third drive gear 23a engages with the third driven gear 23b; the fourth drive gear 24a engages with the fourth driven gear 24b; and the fifth drive gear 25a engages with the fifth driven gear 25b. Further, the reverse drive gear 26a engages with the reverse driven gear 26c via a reverse idler gear (not shown in the drawings).

Next, setup for each gear speed and its power transmission route in the parallel-axes shift mechanism TMM for the automatic transmission TM having the configuration as described above will now be described. In this regard, in this shift mechanism TMM, at a forward (drive) range (D position), the dog tooth clutch 16 is caused to move to the right in FIG. 2, whereby the fourth driven gear 24b engages with the counter shaft 3. Further, at a reverse range (R position), the dog tooth clutch 16 is caused to move to the left in FIG. 2, whereby the reverse driven gear 26c engages with the counter shaft 3.

The respective gear speeds at the forward range will first be described. A low gear speed is set up by causing the low clutch 11 to engage with the low drive gear 21a. Rotational driving force transmitted to the first input shaft 1 from the torque converter TC is transmitted to the second input shaft 2 via the connecting gear train 30. Here, since the low clutch 11 engages with the low drive gear 21a, the low drive gear 21a is driven at the same rotation number as that of the second input shaft 2. With this, the low driven gear 21b that engages with the low drive gear 21a is driven rotatively, and the counter shaft 3 connected to the low driven gear 21b is driven rotatively. This rotational driving force is transmitted to the differential mechanism DR via the final reduction drive gear 6a and the final reduction driven gear (not shown in the drawings).

A second gear speed is set up by causing the second clutch 12 to engage with the second drive gear 22a. Rotational driving force transmitted to the first input shaft 1 from the torque converter TC is transmitted to the second input shaft 2 via the connecting gear train 30. Here, since the second clutch 12 engages with the second drive gear 22a, the second drive gear 22a is driven at the same rotation number as that of the second input shaft 2. With this, the second driven gear 22b that engages with the second drive gear 22a is driven rotatively, and the counter shaft 3 connected to the second driven gear 22b is driven rotatively. This rotational driving force is transmitted to the differential mechanism DR via the final reduction drive gear 6a and the final reduction driven gear (not shown in the drawings).

A third gear speed is set up by causing the third clutch 13 to engage with the third drive gear 23a. Rotational driving force transmitted to the first input shaft 1 from the torque converter TC is transmitted to the second input shaft 2 via the connecting gear train 30. Here, since the third clutch 13 engages with the third drive gear 23a, the third drive gear 23a is driven at the same rotation number as that of the second input shaft 2. With this, the third driven gear 23b that engages with the third drive gear 23a is driven rotatively, and the counter shaft 3 connected to the third driven gear 23b is driven rotatively. This rotational driving force of the counter shaft 3 is transmitted to the differential mechanism DF via the final reduction drive gear 6a and the final reduction driven gear (not shown in the drawings).

A fourth gear speed is set up by causing the fourth clutch 14 to engage with the fourth drive gear 24a. Rotational driving force transmitted to the first input shaft 1 from the torque converter TC causes the fourth drive gear 24a to be driven rotatively via the fourth clutch 14. Thus, the fourth driven gear 24b that engages with the fourth drive gear 24a is driven rotatively. Here, since the fourth driven gear 24b is connected to the counter shaft 3 by means of the dog tooth clutch 16 at the forward range, the counter shaft 3 is driven rotatively, and this rotational driving force of the counter shaft 3 is transmitted to the differential mechanism DF via the final reduction drive gear 6a and final reduction driven gear (not shown in the drawings).

A fifth gear speed is set up by causing the fifth clutch 15 to engage with the fifth drive gear 25a. Rotational driving force transmitted to the first input shaft 1 from the torque converter TC causes the fifth drive gear 25a to be driven rotatively via the fifth clutch 15. Thus, the fifth driven gear 25b that engages with the fifth drive gear 25a is driven rotatively. Since the fifth driven gear 25b is connected to the counter shaft 3, the counter shaft 3 is driven rotatively, and this rotational driving force of the counter shaft 3 is transmitted to the differential mechanism DF via the final reduction drive gear 6a and the final reduction driven gear (not shown in the drawings).

A reverse gear speed is set up by causing the fourth clutch 14 to engage with the fourth drive gear 24a and the reverse drive gear 26a, and to move the dog tooth clutch 16 to the left. Rotational driving force transmitted to the first input shaft 1 from the torque converter TC causes the reverse drive gear 26a to be driven rotatively via the fourth clutch 14. Thus, the reverse driven gear 26c that engages with the reverse drive gear 26a via the reverse idler gear (not shown in the drawings) is driven rotatively. Here, since the reverse driven gear 26c is caused to engage with the counter shaft 3 by means of the dog tooth clutch 16 at the reverse range, the counter shaft 3 is driven rotatively, and this rotational driving force of the counter shaft 3 is transmitted to the differential mechanism DF via the final reduction drive gear 6a and the final reduction driven gear (not shown in the drawings). As is seen from this description, the fourth clutch 14 also has a function of a reverse clutch in accordance with an operation state of the dog tooth clutch 16.

Next, a hydraulic circuit constituting the shift control valve CV, which causes the automatic transmission TM having the configuration as described above to carry out shift control, will be described with reference to FIGS. 3A-3D. FIGS. 3A-3D are a hydraulic circuit diagram showing the whole configuration of the shift control device for the five-gear-speed automatic transmission TM described above. In this regard, in this hydraulic circuit diagram, portions at which an oil passage is opened mean that the oil passage is connected to a drain (oil tank OT).

A hydraulic circuit of the shift control device for the automatic transmission TM according to the present embodiment includes: a hydraulic supply source configured by an oil tank OT and an oil pump OP for discharging hydraulic oil of the oil tank OT; a plurality of frictional engagement elements including the low clutch 11, the second clutch 12, the third clutch 13, the fourth clutch 14 and the fifth clutch 15 for selecting any one of a plurality of power transmission routes of the automatic transmission TM; a regulator valve 50 for regulating line pressure PL, which becomes basis pressure for operating the plurality of frictional engagement elements 11 to 15, from hydraulic pressure supplied from the oil pump OP; a lubricating oil passage extending toward the power transmission mechanism from the regulator valve 50 in order to lubricate the power transmission mechanism; and a group of hydraulic control valves for carrying out supply control of engagement control hydraulic pressure to the frictional engagement elements.

The oil pump OP is driven by the engine ENG to supply the hydraulic oil to an oil passage 100. The oil passage 100 is connected to the regulator valve 50 via an oil passage 100a. The regulator valve 50 regulates the hydraulic oil supplied from the oil pump OP to generate the line pressure PL in the oil passages 100, 100a. This line pressure PL is supplied to a manual valve 56 via an oil passage 100b. The oil passage 100b is always connected to an oil passage 100d via a spool channel and ports of the manual valve 56 (that is, they are always connected to each other no matter how the manual valve 56 is operated), and thus, the line pressure PL is always supplied to first to fourth On/Off solenoid valves 81 to 84 and first and third linear solenoid valves 86, 88 via the oil passage 100d.

As the group of hydraulic control valves, first to third linear solenoid valves 86 to 88 capable of arbitrarily regulating shift control hydraulic pressure on the basis of the line pressure PL at low in-gear control and the like; first to fourth shift valves 61 to 64, a D inhibitor valve 65 and first and second cut valves 91, 92 that carry out selection of oil passages so as to selectively supply the line pressure PL or the shift control hydraulic pressure regulated by any of the first to third linear solenoid valves 86 to 88 (in the present embodiment, the first linear solenoid valve 86 at low in-gear control) to the corresponding frictional engagement element (the low clutch 11 at low in-gear control); and first to fourth On/Off solenoid valves 81 to 84 that supply operation control hydraulic pressure to the first to fourth shift valves 61 to 64 and the D inhibitor valve 65 so as to control operations thereof; are provided.

Surplus hydraulic oil with the line pressure PL regulated in the regulator valve 50 is supplied to an oil passage 191 and an oil passage 192. The hydraulic oil supplied to the oil passage 191 is controlled by a lock-up shift valve 51, a lock-up control valve 52 and a torque converter check valve 53 to use lock-up control of the torque converter TC and supply of the hydraulic oil. After the hydraulic oil is supplied to the torque converter TC, the hydraulic oil is returned to the oil tank OT through an oil cooler OC. In this regard, since control of the torque converter TC is not related to the present invention directly, explanation of its operation is omitted.

Further, the hydraulic oil supplied to the oil passage 192 is supplied to the respective portions as lubricating oil thereof. In the present embodiment, an oil passage 193 branched from the oil passage 192 is provided as a first lubricating oil passage. On the oil passage 193, a check valve 300 is provided for preventing lubricating oil from shafts of the respective clutches 12 to 15 other than the low clutch 11 and the like from flowing out when a second lubricating oil passage (will be described later) is selected. An oil passage 153 branched from the oil passage 193 is connected to a secondary shaft 11b of the low clutch 11 via a lubricating oil choke valve 57 for adjusting the amount of lubricating oil to be outputted on the basis of hydraulic pressure of incoming lubricating oil.

A low accumulator 71, a second accumulator 72, a third accumulator 73, a fourth accumulator 74 and a fifth accumulator 75 are respectively connected to the clutches 11 to 15 via oil passages. Further, in this hydraulic circuit, a forward/reverse selecting hydraulic servo mechanism 55 for operating the dog tooth clutch 16 is provided.

In order to carry out supply control of hydraulic oil pressure to the respective clutches 11 to 15 and the forward/reverse selecting hydraulic servo mechanism 55, as described above, the first shift valve 61, the second shift valve 62, the third shift valve 63, the fourth shift valve 64, the D inhibitor valve 65, the first cut valve 91 and the second cut valve 92 are provided as shown in FIG. 3B. Further, in order to carry out operation control of the respective valves and supply hydraulic control to the respective clutches 11 to 15, the first to fourth On/Off solenoid valves 81 to 84 and the first to third linear solenoid valves 86 to 88 are provided as shown in FIG. 3D.

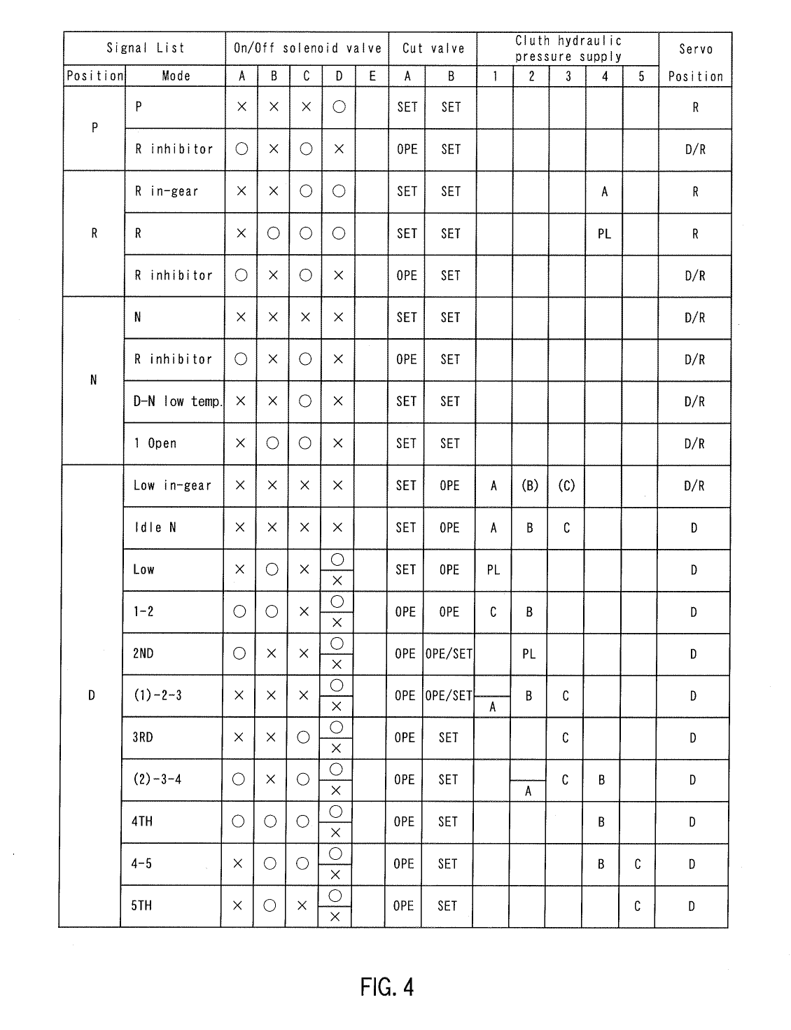

Hereinafter, an operation of the shift control device having the configuration as described above will be described in every gear speed. In setup of the respective gear speeds, switching of oil passages is carried out by moving the spool 56a of the manual valve 56 in response to manipulation of the shift lever 5a of the shift operating device 5, and an operation of each of the first to fourth On/Off solenoid valves 81 to 84 and the first to third linear solenoid valves 86 to 88 is set up by the electronic control unit ECU as shown in a table of FIG. 4. FIG. 4 is a drawing (table) showing relation between the respective shift modes (gears) and operation states of the first to fourth On/Off solenoid valves 81 to 84, the first and second cut valves 91, 92 and the first to third linear solenoid valves 86 to 88. In this regard, each of the first to fourth On/Off solenoid valves 81 to 84 and the first to third linear solenoid valves 86 to 88 is a normal close type solenoid valve, and generates signal hydraulic pressure for the respective shift valves 61 to 64 and the D inhibitor valve 65 by operating to open by application of a current (current application; On).

In FIG. 4, reference numerals “cross mark” and “circle mark” mean Off and On of the current application to each solenoid, respectively. In columns of the On/Off solenoid valves in FIG. 4, reference numerals “A” to “D” mean the first to fourth On/Off solenoid valves 81 to 84, respectively. In this regard, a reference numeral “E” means a fifth On/Off solenoid valve 54 for switching an operation state and a set state of the regulator valve 50. Since an operation of the fifth On/Off solenoid valve 54 is not related to the present invention directly, explanation of its operation is omitted.

Reference numerals “A” and “B” in columns of cut valves in FIG. 4 mean the first and second cut valves 91, 92, respectively. Reference numerals “SET” and “OPE” in the columns of the cut valves indicate a set state and an operation state of the corresponding cut valve, respectively. Moreover, reference numerals “1” to “5” in columns of clutch hydraulic pressure supply mean the low clutch 11, the second clutch 12, the third clutch 13, the fourth (reverse) clutch 14 and the fifth clutch 15, respectively. As can be seen from the above explanation, the same clutch 14 functions as the reverse clutch and the fourth clutch.

In the columns of the clutch hydraulic pressure supply in FIG. 4, reference numeral “PL” means that hydraulic oil with the line pressure PL is supplied to the corresponding clutch, and reference numerals “A” to “C” mean that hydraulic oil outputted from the first to third linear solenoid valves 86 to 88 is supplied to the corresponding clutch, respectively. Moreover, a column of a servo position indicates to which of R (reverse) and D (forward) the forward/reverse selecting hydraulic servo mechanism 55 is operated.

A column of a position in FIG. 4 indicates an operation position of the shift lever 5a and an operation position of the manual valve 56, and at least a parking (P) position, a reverse (R) position, a neutral (N) position and a forward (D) position are provided as the positions. In this regard, FIG. 3C shows a state where the manual valve 56 is positioned at an N position.

Various modes set up when the shift lever 5a is positioned at any one of the parking (P) position, the reverse (R) position, the neutral (N) position and the forward (D) position are shown in FIG. 4. However, the present invention is intended to shift control of the forward (D) position, particularly, shift control at neutral idle control and low clutch engaging control. For this reason, the shift control at low in-gear control, the neutral idle control and the low clutch engaging control of the forward (D) position will hereinafter be described, and explanation of shift control at the other position is omitted.

In this regard, the neutral idle control is control in which the automatic transmission TM is shifted to a pseudo neutral state (neutral (N) position-like state) in the case where predetermined conditions are met even when a shift range of the automatic transmission TM is set to the drive (forward) D range. The predetermined conditions include: a condition that the degree of opening of an accelerator pedal becomes a predetermined value or lower; a condition that a brake pedal is depressed; and a condition that vehicle speed becomes a predetermined value or slower.

In this regard, 10 kinds of modes as shown in FIG. 4 are set up when the shift lever 5a is manipulated to the forward (D) position. Further, the spool 56a of the manual valve 56 is moved at this time so that a groove portion 56b becomes the D position, and the line pressure PL of the oil passage 100b is also supplied to an oil passage 101.

A low in-gear mode set up as an initial step when the shift lever 5a is manipulated from a neutral (N) position to a forward (D) position will first be described. In this mode, all of the first to fourth On/Off solenoid valves 81 to 84 are set to an Off operation. For this reason, hydraulic pressure of each of oil passages 111 to 114 to which output pressure of the respective first to fourth On/Off solenoid valves 81 to 84 is to be supplied becomes zero or extremely low pressure.

The oil passage 111 is connected to a far right port 61c of the first shift valve 61 via an oil passage 111a. However, since hydraulic pressure applied to this port is zero, a spool 61a is pressed to the right in FIG. 3B by means of a spring 61b to become a set state (the state shown in the drawing). Further, the oil passage 111 is also connected to a far left port 91c of the first cut valve 91 via an oil passage 111b. However, since hydraulic pressure applied to this port is zero, a spool 91a is pressed to the left in FIG. 3C by means of a spring 91b to become a set state (the state shown in the drawing).

The oil passage 112 is connected to a far right port 62c of the second shift valve 62. However, since hydraulic pressure applied to this port is zero, a spool 62a is pressed to the right in FIG. 3C by means of a spring 62b to become a set state (the state shown in the drawing).

The oil passage 113 is connected to a far right port 92d of the second cut valve 92 via an oil passage 113a, and a spool 92a is pressed to the left in FIG. 3C by means of a spring 92b to become a set state (the state shown in the drawing). Further, the oil passage 113 is also connected to a far right port 63c of the third shift valve 63 via an oil passage 113b. However, since hydraulic pressure applied to this port is zero, a spool 63a is pressed to the right in FIG. 3B by means of a spring 63b to become a set state (the state shown in the drawing).

The oil passage 114 is connected to a far left port 64c of the fourth shift valve 64 via an oil passage 114a. However, since hydraulic pressure applied to this port is zero, a spool 64a is pressed to the left in FIG. 3B by means of a spring 64b to become a set state (the state shown in the drawing). Further, the oil passage 114 is also connected to a far right port 51c of the lock-up shift valve 51 via an oil passage 114b. However, since hydraulic pressure applied to this port is zero, a spool 51a is pressed to the right in FIG. 3A by means of a spring 51b to become a set state (the state shown in the drawing).

As described above, in the initial state of the low in-gear mode, all of the first to fourth shift valves 61, 62, 63, 64 and the first and second cut valves 91, 92 become the set state. At these states, engagement control of the low clutch 11 is carried out using engagement control hydraulic pressure outputted to an oil passage 115 from the first linear solenoid valve 86.

An oil passage 115a is branched from the oil passage 115 to which the engagement control hydraulic pressure is outputted from the first linear solenoid valve 86. The oil passage 115a is connected to an oil passage 116 via a spool channel of the lock-up shift valve 51 at a set state, and the oil passage 116 is connected to an oil passage 117 via a spool channel of the second shift valve 62 at a set state.

The oil passage 117 is connected to an oil passage 118 via a spool channel of the manual valve 56 positioned at the D position. An oil passage 118a branched from the oil passage 118 is connected to an oil passage 119 via a spool channel of the first shift valve 61 at a set state. The oil passage 119 is connected to an oil passage 120 via a spool channel of the third shift valve 63 at a set state.

The oil passage 120 is connected to a primary shaft 11a of the low clutch 11. The engagement control hydraulic pressure outputted to the oil passage 115 from the first linear solenoid valve 86 is supplied to the low clutch 11 in this manner, whereby the engagement control for the low clutch 11 is carried out.

In this case, an oil passage 120a branched from the oil passage 120 is connected to a far left port 92c of the second cut valve 92. For this reason, in the case where the engagement control hydraulic pressure applied to the low clutch 11 exceeds predetermined pressure, the spool 92a is moved to the right against biasing force of the spring 92b, whereby the second cut valve 92 becomes an operation state.

Thus, a port 92e of the second cut valve 92 is connected to a port 92f via a spool channel. Here, as described above, the oil passage 101a branched from the oil passage 101, to which the line pressure PL is supplied from the oil passage 100b via the spool channel of the manual valve 56, is connected to the port 92e via a branched oil passage 101b. The line pressure PL supplied from the port 92e is applied to a step portion of the spool 92a, whereby the second cut valve 92 is held (self-locked) at a state where the spool 92a is moved to the right. Namely, in the case where the engagement control hydraulic pressure applied to the low clutch 11 exceeds the predetermined pressure and the spool 92a is thereby moved to the right, the spool 92a is pressed to the right by the line pressure PL supplied from the port 92e, whereby the second cut valve 92 is held (self-locked) at an operation state.

Further, an oil passage 120b branched from the oil passage 120 is connected to a port 65e of the D inhibitor valve 65. The line pressure PL is applied to a step portion of a spool 65a of the D inhibitor valve 65 to press the spool 65a to the right. For this reason, in the case where the engagement control hydraulic pressure applied to the low clutch 11 exceeds the predetermined pressure, the spool 65a is moved to the right against biasing force of a spring 65b, whereby the D inhibitor valve 65 becomes an operation state.

Thus, a port 65f is connected to a port 65g via a spool channel of the D inhibitor valve 65. However, as described above, the oil passage 101a branched from the oil passage 101, to which the line pressure PL is supplied from the oil passage 100b via the spool channel of the manual valve 56, is connected to the port 65f via a branched oil passage 101c. The line pressure PL supplied from the port 65f is applied to a step portion of the spool 65a, whereby the D inhibitor valve 65 is held (self-locked) at a state where the spool 65a is moved to the right. Namely, in the case where the engagement control hydraulic pressure applied to the low clutch 11 exceeds the predetermined pressure and the spool 65a is thereby moved to the right, the spool 65a is pressed to the right by the line pressure PL supplied from the port 65f, whereby the D inhibitor valve 65 is held (self-locked) at an operation state.

When the D inhibitor valve 65 is in the operation state, the port 65f is connected to the port 65g. For this reason, the line pressure PL is supplied to an oil passage 102 connected to the port 65g, and the line pressure PL is supplied to a right-side oil chamber 55b of the forward/reverse selecting hydraulic servo mechanism 55.

In this case, a left-side oil chamber 55c is connected to a drain via a spool channel of the fourth shift valve 64 at a set state, whereby a rod 55a becomes an operation state. This rod 55a is connected to a shift fork (not shown in the drawings) for operating the dog tooth clutch 16. When the rod 55a is in the operation state, the fourth driven gear 24b is connected to the counter shaft 3 by means of the dog tooth clutch 16.

In this regard, the line pressure PL supplied to the right-side oil chamber 55b of the forward/reverse selecting hydraulic servo mechanism 55 is supplied to the second linear solenoid valve 87 via an oil passage 103. Further, the line pressure PL supplied to the oil passage 101 is supplied to the third linear solenoid valve 88 via an oil passage 101d. An oil passage 100f is also branched from the oil passage 100d to which the line pressure PL is always supplied by being connected to the oil passage 100b via the spool channel of the manual valve 56. The line pressure PL supplied to the oil passage 100f is supplied to the first linear solenoid valve 86.

In the low in-gear mode, the second clutch 12 is connected to an output port of the second linear solenoid valve 87, thereby being drained; the third clutch 13 is connected to an output port of the third linear solenoid valve 88, thereby being drained; the fourth clutch 14 is connected to the third shift valve 63 via the fourth shift valve 64, thereby being drained; and the fifth clutch 15 is connected to the first cut valve 91 via the first shift valve 61, thereby being drained. All of the clutches 11 to 15 become an open state.

Next, a low mode will be described. In the low mode, the second On/Off solenoid valve 82 is set to an On operation from a state of the low in-gear mode. Thus, the line pressure PL is supplied to the far right port 62c of the second shift valve 62 via the oil passage 112, and the spool 62a of the second shift valve 62 is operated to set the second shift valve 62 to an operation state.

As a result, an oil passage 100e is branched from the oil passage 100d, which is always connected to the oil passage 100b via the port and the spool channel of the manual valve 56 and to which the line pressure PL is supplied. The oil passage 100e is connected to an oil passage 104 via a spool channel of the second cut valve 92 at an operation state, and the oil passage 104 is connected to an oil passage 105 via a spool channel of the first cut valve 91 at a set state.

Moreover, the oil passage 105 is connected to the oil passage 117 via the spool channel of the second shift valve 62 at an operation state. The oil passage 117 is connected to the oil passage 118 via the spool channel of the manual valve 56 whose spool 56a is positioned at the D position. The oil passage 118 is connected to the oil passage 119 via the spool channel of the first shift valve 61 at a set state. The oil passage 119 is connected to the oil passage 120 via the spool channel of the third shift valve 63 at a set state. The oil passage 120 is connected to the primary shaft 11a of the low clutch 11, and as a result, the line pressure PL is supplied to the low clutch 11, whereby the low clutch 11 is caused to engage completely to set up a low gear speed (low gear).

In this regard, FIG. 4 shows that the fourth On/Off solenoid valve 84 is set to an On or Off operation in the low mode. The oil passage 114 to which the hydraulic pressure outputted from the fourth On/Off solenoid valve 84 is supplied is connected to the far right port 51c of the lock-up shift valve 51 via the oil passage 114b, as described above. The hydraulic pressure outputted from the fourth On/Off solenoid valve 84 is used to control an operation of the lock-up shift valve 51, that is, an operation of the lock-up clutch of the torque converter TC.

Such control for the lock-up clutch operation by the fourth On/Off solenoid valve 84 is carried out in any of the modes described under the low mode in FIG. 4 in the similar manner. Namely, in all of the modes other than the low in-gear mode and a neutral idle mode (will be described later) on the D position shown in FIG. 4, the fourth On/Off solenoid valve 84 is used to control the operation of the lock-up clutch, and setup of shift control modes is carried out by means of the first to third On/Off solenoid valves 81 to 83.

Next, a neutral idle control mode will be described. The second On/Off solenoid valve 82 is set to an Off operation from a state of the low mode, whereby the neutral idle control mode is set up. Thus, all of the first to third On/Off solenoid valves 81 to 83 are set to an Off operation, but this state is the same as that in the low in-gear mode. However, as described above, the D inhibitor valve 65 and the second cut valve 92 are in the state of the self-locked operation state at this time. The state of the neutral idle control mode is different from the state of the low in-gear mode on this point.

As described above, the control hydraulic pressure outputted to the oil passage 115 from the first linear solenoid valve 86 is connected to the oil passage 116 via the spool channel of the second shift valve 62 at a set state. The oil passage 116 is connected to the oil passage 117 via the spool channel of the lock-up shift valve 51 at a set state. The oil passage 117 is connected to the oil passage 118 via the spool channel of the manual valve 56 whose spool 56a is positioned at the D position. The oil passage 118 is connected to the oil passage 119 via the spool channel of the first shift valve 61 at a set state. The oil passage 119 is connected to the oil passage 120 via the spool channel of the third shift valve 63 at a set state. The oil passage 120 is connected to the primary shaft 11a of the low clutch 11. The control hydraulic pressure outputted from the first linear solenoid valve 86 is supplied to the low clutch 11, whereby the engagement control for the low clutch 11 is carried out.

The control hydraulic pressure outputted to an oil passage 141 from the second linear solenoid valve 87 is connected to an oil passage 142 via an oil passage 141a branched from the oil passage 141 and the spool channel of the third shift valve 63 at a set state. The oil passage 142 is connected to an oil passage 143 via the spool channel of the first shift valve 61 at a set state. The oil passage 143 is connected to an oil passage 144 via the spool channel of the second shift valve 62 at a set state. The oil passage 144 is connected to the second clutch 12, whereby the control hydraulic pressure outputted from the second linear solenoid valve 87 is supplied to the second clutch 12.

The control hydraulic pressure outputted to an oil passage 131 from the third linear solenoid valve 88 is connected to an oil passage 134 via the spool channel of the second shift valve 62 at a set state. An oil passage 134a branched from the oil passage 134 is connected to an oil passage 135 via the first shift valve 61 at a set state. The oil passage 135 is connected to an oil passage 136 via the third shift valve 63 at a set state. The oil passage 136 is connected to the third clutch 13, whereby the control hydraulic pressure outputted from the third linear solenoid valve 88 is supplied to the third clutch 13.

Thus, in the neutral idle mode, the control hydraulic pressure outputted from the respective first to third linear solenoid valves 86 to 88 is supplied to the low clutch 11, the second clutch 12 and the third clutch 13. However, in the low clutch 11, temperature around the low clutch 11 rises due to drag of the low clutch 11. For that reason, it is not enough to lubricate the low clutch 11 with the hydraulic oil with the control hydraulic pressure supplied from the first linear solenoid valve 86. In the present embodiment, in order to solve such a problem, a second lubricating oil passage (will be described later) for using the hydraulic oil with the line pressure PL as lubricating oil is provided.

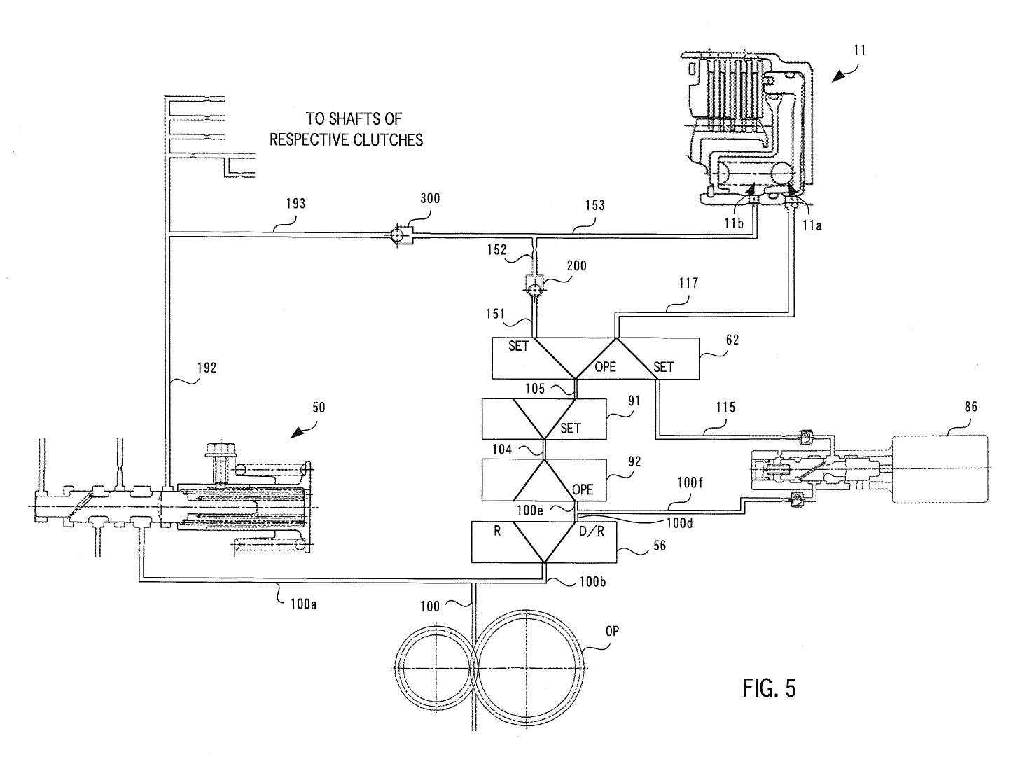

Hereinafter, low clutch lubricating control of the shift control device for the automatic transmission TM according to the present embodiment will be described in detail with reference to FIGS. 3A-3D and FIG. 5. FIG. 5 is a part of a schematic hydraulic circuit diagram according to the first embodiment. In FIG. 5, constituent elements related to two routes of hydraulic oil passages for supplying the hydraulic oil to the low clutch 11 and two routes of lubricating oil passages for supplying the lubricating oil to the low clutch 11 are mainly shown, and the other oil passages and valves are omitted.

In the present embodiment, in order to set up the low gear speed (low gear), in the low in-gear mode, the hydraulic oil is supplied to the manual valve 56 from the oil pump OP via the oil passages 100 and 100b; is outputted to the oil passage 100d from the manual valve 56; and is supplied to the first linear solenoid valve 86 via the oil passage 100f. Moreover, the control hydraulic pressure outputted from the first linear solenoid valve 86 is supplied to the second shift valve 62 at a set state via the oil passage 115; is outputted to the oil passage 117 from the second shift valve 62; and is then supplied to the primary shaft 11a of the low clutch 11 via the manual valve 56, the first shift valve 61 and the third shift valve 63. This supply line of the hydraulic oil is referred to as a “first hydraulic oil passage”. Further, in the low mode (low stationary mode), the hydraulic oil is supplied to the regulator valve 50 via the oil passages 100 and 100a from the oil pump OP. After the supplied hydraulic oil is regulated to the line pressure PL by means of this regulator valve 50, the regulated line pressure PL is supplied to the primary shaft 11a of the low clutch 11 via the manual valve 56 at the forward range (D position), the second cut valve 92 at the operation state, the first cut valve 91 at the set state, the second shift valve 62 at the operation state, the manual valve 56 at the forward range (usage of a different port) and the third shift valve 63 at the set state. This supply line of the hydraulic oil is referred to as a “second hydraulic oil passage”.

In this regard, when the first hydraulic oil passage is selected, the operation control of the low clutch 11 is a low clutch linear solenoid control mode in which the hydraulic oil pressure to the low clutch 11 is controlled by the first linear solenoid valve 86. When the second hydraulic oil passage is selected, the operation control of the low clutch 11 is a low stationary mode in which the line pressure PL is directly supplied to the low clutch 11 via the first and second cut valves 91, 92. As described above and as shown in FIG. 5, On/Off of the second On/Off solenoid valve 82 is controlled by supplying a solenoid signal to the second On/Off solenoid valve 82, whereby the second shift valve 62 is switched between an operation state and a set state. Thus, a route to supply the hydraulic oil to the low clutch 11 is switched between the first hydraulic oil passage and the second hydraulic oil passage.

Further, in the present embodiment, in order to lubricate the low clutch 11, the hydraulic oil is supplied to the regulator valve 50 via the oil passages 100 and 100a from the oil pump OP; is outputted from the regulator valve 50 as surplus hydraulic oil; is supplied to the lubricating oil choke valve 57 via the oil passages 192 and 193; and the amount of lubricating oil adjusted in accordance with the supplied hydraulic pressure in the lubricating oil choke valve 57 is supplied to the secondary shaft 11b of the low clutch 11. This supply line of the lubricating oil is referred to as a “first lubricating oil passage”. Moreover, in addition to this first lubricating oil passage, the hydraulic oil with the line pressure PL supplied via the oil passage 105 using the same spool channel as used in the second shift valve 62 at the operation state in the second hydraulic oil passage when the second shift valve 62 is in the set state is outputted to an oil passage 151 from the second shift valve 62 as lubricating oil for the low clutch 11, and is supplied to the secondary shaft 11b of the low clutch 11 via the oil passage 151, an oil passage 152, the lubricating oil choke valve 57 and the oil passage 153. This supply line of the lubricating oil is referred to as a “second lubricating oil passage”.

Therefore, in the hydraulic circuit according to the present embodiment, On/Off of the second On/Off solenoid valve 82 is controlled by supplying a solenoid signal to the second On/Off solenoid valve 82, whereby the second shift valve 62 is switched between the operation state and the set state. When the second shift valve 62 becomes the set state, the second lubricating oil passage is selected together with the first hydraulic oil passage, whereby the lubricating oil with the line pressure PL is supplied to the secondary shaft 11b of the low clutch 11.

Here, as shown in FIGS. 3A-3D and FIG. 5, the check valve 300 is provided on the oil passage 193 of the first lubricating oil passage. When the lubricating oil with the line pressure PL is supplied to the secondary shaft 11b of the low clutch 11 by selecting the second lubricating oil passage, this check valve 300 prevents the lubricating oil from flowing out from shafts of the respective clutches 12 to 15 other than the low clutch 11 and the like. In this regard, the check valve 300 is opened when the pressure of the lubricating oil supplied from the regulator valve 50 becomes a predetermined value or higher, whereby the lubricating oil is supplied to the secondary shaft 11b of the low clutch 11 via the first lubricating oil passage.

Further, a check valve 200 is provided as an outflow preventing section between the oil passage 151 and the oil passage 152 of the second lubricating oil passage. When the second lubricating oil passage is not selected, that is, when the hydraulic oil with the line pressure PL is supplied to the primary shaft 11a of the low clutch 11 via the second hydraulic oil passage and the lubricating oil is supplied to the secondary shaft 11b of the low clutch 11 via the first lubricating oil passage, the check valve 200 prevents the lubricating oil supplied to the secondary shaft 11b of the low clutch 11 via the first lubricating oil passage from flowing out from any open port provided in the respective valves of the hydraulic circuit to be drained.

Thus, the second lubricating oil passage is provided in addition to the first lubricating oil passage, and the check valve 300 and the check valve 200 (outflow preventing section) are respectively provided on the first lubricating oil passage and the second lubricating oil passage, whereby it is possible to supply the lubricating oil with the line pressure PL to the secondary shaft 11b of the low clutch 11 from the second lubricating oil passage at the neutral idle control. This makes it possible to resolve a problem that the amount of lubricating oil supplied to the low clutch 11 via the first lubricating oil passage has been lowered at the neutral idle control in the conventional hydraulic circuit, and it is possible to improve lubrication of the low clutch 11. Therefore, it is possible to effectively prevent burn-in (or burnout) due to drag of the low clutch 11 at the neutral idle control.

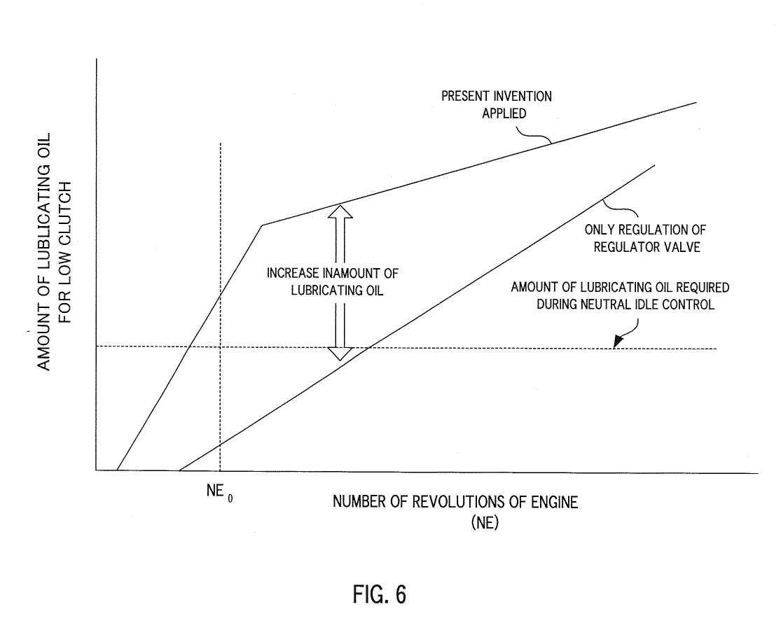

Here, how the amount of lubricating oil for the low clutch 11 increases by applying the present invention thereto will be described on a conceptual basis with reference to FIG. 6. FIG. 6 is a graph showing a relation between the number of revolutions of the engine ENG and the amount of lubricating oil for the low clutch 11.

Conventionally, the lubricating oil regulated by the regulator valve 50 has been supplied to the secondary shaft 11b of the low clutch 11 via the first lubricating oil passage. In this regard, no check valve 300 has been provided in the conventional hydraulic circuit. In this case, it was impossible to ensure a large amount of lubricating oil required during the neutral idle control at the number of revolutions of the engine ENG in the order of idling of the engine ENG, for example. As shown in FIG. 6, only regulation of the regulator valve 50 cannot ensure the sufficient amount of lubricating oil for the low clutch 11 at the number of revolutions NE₀ of the engine ENG at an idling state of the engine ENG.

On the other hand, as the present embodiment, the second lubricating oil passage branched from the second hydraulic oil passage through the same spool channel of the second shift valve 62 is provided, and the lubricating oil with the line pressure PL is supplied to the secondary shaft 11b of the low clutch 11 via the second shift valve 62 in the low clutch linear solenoid control mode by the first linear solenoid valve 86 during the neutral idle control. Thus, as shown in FIG. 6, even at the idling state of the engine ENG, it is possible to sufficiently ensure the amount of lubricating oil required during the neutral idle control. This makes it possible to effectively prevent burn-in (or burnout) of the low clutch 11 due to drag of the low clutch 11 at the neutral idle control, in particular.

In this regard, no lubrication pressure to the secondary shaft 11b of the low clutch 11 is generated in accordance with the operations of the first and second cut valves 91, 92 regardless of a state of the second shift valve 62 in any mode other than the low clutch linear solenoid control mode and the low stationary mode. Thus, by increasing the amount of lubricating oil for the low clutch 11, it is possible to effectively prevent burnout of the low clutch 11 only if needed. Further, in the case where there is no need for a large amount of lubricating oil, the amount of lubricating oil is prevented from increasing by closing the second lubricating oil passage, whereby it is possible to prevent friction of the low clutch 11 from deteriorating.

Further, in the present embodiment, as described above, the second lubricating oil passage is branched from the second hydraulic oil passage using the same spool channel of the second shift valve 62. For this reason, it is possible to achieve sufficient lubrication of the low clutch 11 by a simple structure and its operation control while inhibiting size up of the second shift valve 62.

### Second Embodiment

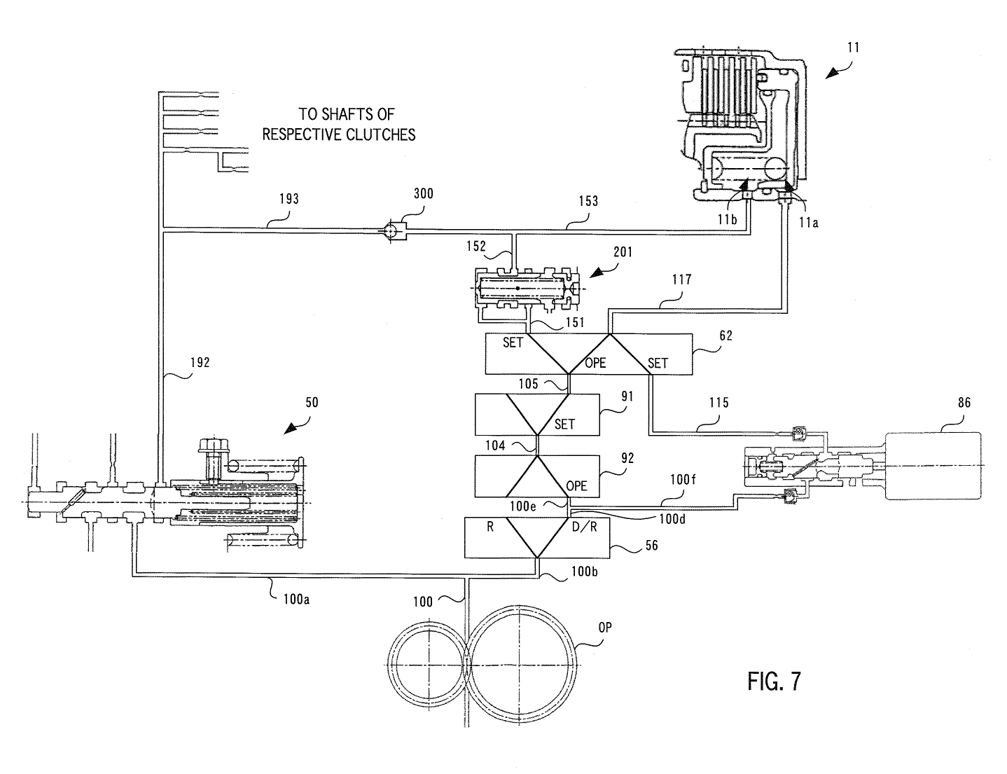

Next, low clutch lubricating control of a shift control device for an automatic transmission TM according to a second embodiment of the present invention will be described in detail with reference to FIG. 7. FIG. 7 is a part of a schematic hydraulic circuit diagram according to the second embodiment of the present invention. In this regard, the same reference numerals are assigned to constituent elements similar to or the same as those in the first embodiment, its detailed explanation is omitted, and differences from the first embodiment will be explained mainly. FIG. 7 mainly shows, as well as FIG. 5, hydraulic oil passages for supplying hydraulic oil to a low clutch 11, and constituent elements related to first and second lubricating oil passages for supplying lubricating oil, and other oil passages and valves are omitted in FIG. 7.

The hydraulic circuit according to the second embodiment is different from the hydraulic circuit according to the first embodiment described above on two points. As one point, the hydraulic oil is supplied to a primary shaft 11a of the low clutch 11 via a second hydraulic oil passage. As the other point, a lubricating oil switching valve 201 for switching whether or not lubricating oil is supplied to a secondary shaft 11b of the low clutch 11 is provided as an outflow preventing section in place of the check valve 200. The lubricating oil switching valve 201 prevents the lubricating oil supplied to the secondary shaft 11b of the low clutch 11 via a first lubricating oil passage from flowing out from any open port provided in the respective valves of the hydraulic circuit to be drained when the hydraulic oil is supplied to the primary shaft 11a of the low clutch 11 via a second hydraulic oil passage and the lubricating oil is supplied to the secondary shaft 11b of the low clutch 11 via the first lubricating oil passage.

Next, an operation of the hydraulic circuit according to the present embodiment will be described. In the present embodiment, when a large amount of lubricating oil is required, for example, during neutral idle control, the hydraulic oil with line pressure PL supplied via an oil passage 105 using the same spool channel as used in a second shift valve 62 at an operation state in the second hydraulic oil passage when this second shift valve 62 is in a set state is outputted to an oil passage 151 from the second shift valve 62 as lubricating oil for the low clutch 11. The lubricating oil switching valve 201 is then set to the operation state by the line pressure PL supplied to the oil passage 151, whereby the oil passage 151 is connected to an oil passage 152. The oil passage 152 is connected to the secondary shaft 11b of the low clutch 11 via an oil passage 153. Thus, the hydraulic oil with the line pressure PL supplied to the second shift valve 62 via first and second cut valves 91, 92 is supplied to the secondary shaft 11b of the low clutch 11 as the lubricating oil for the low clutch 11.

Thus, when the lubricating oil is supplied to the secondary shaft 11b of the low clutch 11 via the second lubricating oil passage in the hydraulic circuit provided with the lubricating oil switching valve 201 in place of the check valve 200, the lubricating oil switching valve 201 is set to an On operation (open). Otherwise, this lubricating oil switching valve 201 is set to an Off operation (close). This makes it possible to improve lubrication of the low clutch 11, and it is possible to effectively prevent burn-in (or burnout) of the low clutch 11 due to drag of the low clutch 11 at the neutral idle control.

### Third Embodiment

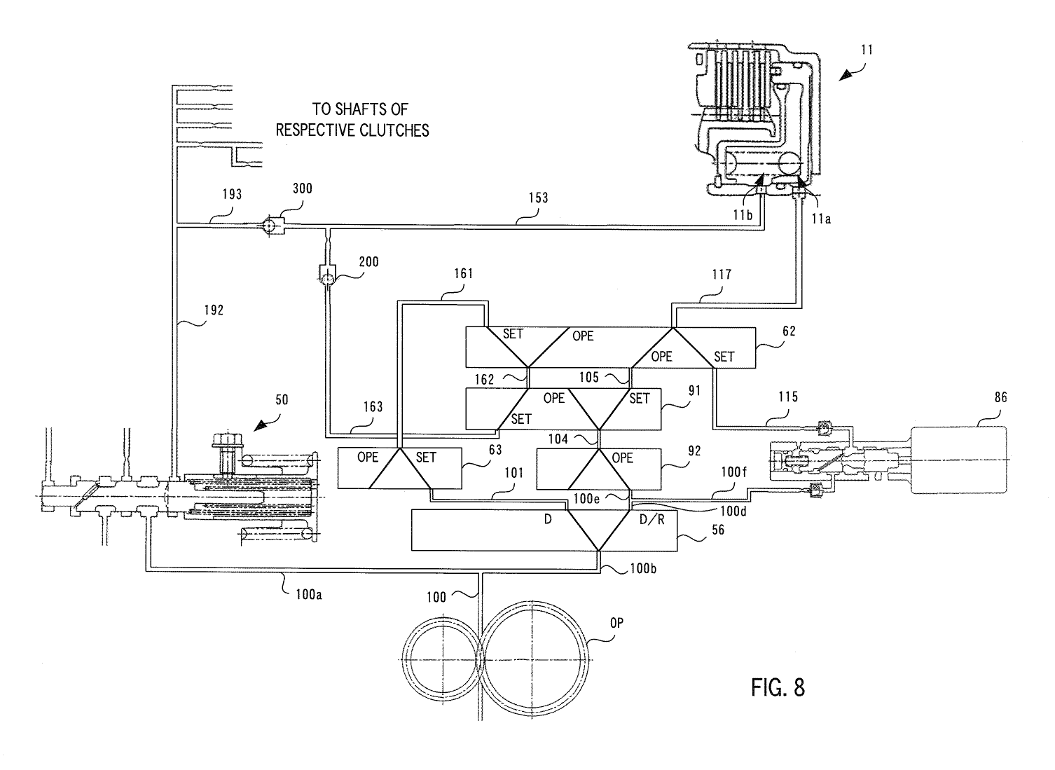

Next, low clutch lubricating control of a shift control device for an automatic transmission TM according to a third embodiment of the present invention will be described in detail with reference to FIG. 8. FIG. 8 is a part of a schematic hydraulic circuit diagram according to the third embodiment of the present invention. In this regard, the same reference numerals are assigned to constituent elements similar to or the same as those in the first embodiment, its detailed explanation is omitted, and differences from the first embodiment will be explained mainly. FIG. 8 mainly shows, as well as FIG. 5, hydraulic oil passages for supplying hydraulic oil to a low clutch 11, and constituent elements related to first and second lubricating oil passages for supplying lubricating oil, and other oil passages and valves are omitted in FIG. 8.

In the hydraulic circuit according to the third embodiment, a route of the second lubricating oil passage is different from that in the first embodiment. Namely, the whole layout of the hydraulic circuit according to the third embodiment is different from that in the first embodiment, and the hydraulic circuit according to the third embodiment is different from the hydraulic circuit according to the first embodiment described above on the point that switching of the second lubricating oil passage is carried out using a spool channel of a second shift valve 62 different from a spool channel used in a second hydraulic oil passage.

This hydraulic circuit shows a part of the hydraulic circuit in current fleet vehicles, but the hydraulic circuit is configured so as to be capable of selecting the second lubricating oil passage using the second shift valve 62 for switching a low clutch linear solenoid control mode and a low stationary mode in the similar manner to the first and second embodiments described above.

By setting up the second shift valve 62 of this hydraulic circuit from an operation state to a set state using the spool channel different from the spool channel used in the second hydraulic oil passage, it is possible to switch from the first lubricating oil passage to the second lubricating oil passage. Namely, in the similar manner to the first and second embodiments described above, in the case where the respective valves are in predetermined states when the second shift valve 62 is in a set state, the lubricating oil with line pressure PL is supplied to a secondary shaft 11b of the low clutch 11 via the second lubricating oil passage.

More specifically, as shown in FIG. 8, when a forward (drive) shift is selected in a manual valve 56, the hydraulic oil is supplied to the manual valve 56 from an oil pump OP via oil passages 100 and 100b to be outputted to an oil passage 101 from the manual valve 56. The hydraulic oil is outputted to an oil passage 161 via a spool channel of a third shift valve 63 and a spool channel of a first shift valve 61 (not shown in the drawings), and is supplied to the second shift valve 62 at a set state. Moreover, the hydraulic oil is outputted to an oil passage 162 via a spool channel of the second shift valve 62 different from those in the case of the first and second hydraulic oil passages, and is then outputted to an oil passage 163 via a first cut valve 91 at a set state to be supplied to the secondary shaft 11b of the low clutch 11 via a lubricating oil choke valve 57 and an oil passage 153 as lubricating oil with the line pressure PL.

Thus, in the present embodiment different from the first and second embodiments in which the second lubricating oil passage is branched from the second hydraulic oil passage by the second shift valve 62, the second lubricating oil passage is connected directly to the secondary shaft 11b of the low clutch 11 from the oil pump OP that is a hydraulic supply source via a predetermined group of valves (in the present embodiment, the third shift valve 63, the first shift valve 61 and the first cut valve 91) including the second shift valve 62.

In such a configuration, compared with the hydraulic circuits in the first and second embodiments, a route of the hydraulic circuit becomes somewhat complicated, but a small change (or modification) to add two ports to the second cut valve 91 allows the lubricating oil with the line pressure PL to be supplied to the secondary shaft 11b of the low clutch 11 by selecting the second lubricating oil passage in accordance with whether the second shift valve 62 is set to a set state or an operation state. Therefore, it is possible to improve lubrication of the low clutch 11 in the case of the hydraulic circuit according to the first embodiment, and it is possible to effectively prevent burn-in (or burnout) of the low clutch 11 due to drag of the low clutch 11 at the neutral idle control.

As explained above, according to the shift control device for the automatic transmission TM of the present invention, the shift control device for the automatic transmission TM includes: the group of hydraulic control valves for carrying out supply control of engagement control hydraulic pressure to the respective clutches 11 to 15, the group of hydraulic control valves including the first to third linear solenoid valves 86 to 88 capable of arbitrarily regulating shift control hydraulic pressure, the first to fourth shift valves 61 to 64 and the first and second cut valves 91, 92 for carrying out selection of an oil passage so as to selectively supply the line pressure PL or the shift control hydraulic pressure regulated by any of the first to third linear solenoid valves 86 to 88 to the respective clutches 11 to 15, and the first to fourth On/Off solenoid valves 81 to 84 for supplying operation control hydraulic pressure to the first to fourth shift valves 61 to 64 to control operations thereof; hydraulic oil passages including the first hydraulic oil passage for supplying the shift control hydraulic pressure, supplied from the first linear solenoid valve 86 for setting up the low gear speed of the first to third linear solenoid valves 86 to 88, to the low clutch 11 that is one of the respective clutches 11 to 15 and the second hydraulic oil passage for supplying the line pressure PL regulated by the regulator valve 50 to the low clutch 11, the first hydraulic oil passage and the second hydraulic oil passage being switched in accordance with the operation state and the set state of the second shift valve 62, selection of the hydraulic oil passage being carried out by controlling operations of the first to fourth shift valves 61 to 64 in accordance with combination of On/Off operations of the first to fourth On/Off solenoid valves 81 to 84, the same On/Off operation combination pattern of the first to fourth On/Off solenoid valves 81 to 84 being set up in each of an operation state and the set state of the first and second cut valves 91, 92 to set up different gears; lubricating oil passages oil passage for supplying lubricating oil to the respective portions via the oil passage 192 extending toward the power transmission mechanism TMM from the regulator valve 50 to lubricate the power transmission mechanism TMM, the lubricating oil passages including the first lubricating oil passage for supplying lubricating oil to the low clutch 11 used to set up the low gear speed and the second lubricating oil passage for supplying lubricating oil with the line pressure PL to the low clutch 11, the second lubricating oil passage being selected by setting up the second shift valve 62 to the set state under the predetermined condition; the check valve 300 provided on the first lubricating oil passage, the check valve 300 preventing the lubricating oil from flowing out from the shaft of the second clutch 12 or the like other than the low clutch 11 when the second lubricating oil passage is selected; and an outflow preventing section (the check valve 200 or the lubricating oil switching valve 201) provided on the second lubricating oil passage, the outflow preventing section (the check valve 200 or the lubricating oil switching valve 201) preventing the lubricating oil, supplied to the low clutch 11 via the first lubricating oil passage, from flowing out from any open port of the group of hydraulic control valves and the like when the second lubricating oil passage is not selected (that is, when the second hydraulic oil passage and the first lubricating oil passage are selected). Thus, by setting up the second shift valve 62 to the set state to select the second lubricating oil passage under the predetermined condition (for example, during neutral idle control or the like), it is possible to supply the sufficient amount of lubricating oil with the line pressure PL to the low clutch 11 in a situation in which temperature around the low clutch 11 rises. This makes it possible to effectively prevent burn-in (or burnout) of the low clutch 11 due to drag of the low clutch 11 at neutral idle control. Further, in the case where the amount of lubricating oil for the low clutch 11 is enough, it is possible to stop supplying the lubricating oil with the line pressure PL to the low clutch 11 by setting up the second shift valve 62 to the operation state. Therefore, it is possible to prevent friction of the low clutch 11 from deteriorating due to increase in the amount of lubricating oil in such a case.

As described above, although the embodiments of the shift control device for the automatic transmission according to the present invention have been explained in detail on the basis of the appending drawings, the present invention is not limited to these configurations. Various modifications can be made in a scope of the technical idea described in the following claims, the specification described above and the appending drawings without departing from the spirit and scope of the present invention. In this regard, even any shape, structure or function that is not described directly in the specification and the drawings falls within the technical idea of the present invention so long as the function and the effect of the present invention are achieved. Namely, each component constituting the shift control device for the automatic transmission (including the hydraulic circuit) can be replaced with any arbitrary component that can achieve the similar function to the corresponding component of the shift control device for the automatic transmission. Further, arbitrary components may be added to the shift control device for the automatic transmission.

In this regard, in the third embodiment described above, the hydraulic circuit including the plurality of valves (here, the first shift valve 61, the first cut valve 91 and the like) including the second shift valve 62 in the second lubricating oil passage has been described as one example. However, the present invention is not limited to such a complicated hydraulic circuit. Namely, the second lubricating oil passage may have any route, so long as a shift control device for an automatic transmission capable of switching a low clutch linear solenoid control mode and a low stationary mode using one shift valve (here, the second shift valve 62) is configured so as to be further capable of selecting the second lubricating oil passage using this shift valve.

What is claimed is:

1. A shift control device for an automatic transmission, comprising:
a power transmission mechanism for carrying out transmission of drive power, the power transmission mechanism having a plurality of power transmission routes;
a plurality of frictional engagement elements for selecting any one of the power transmission routes, any one of the plurality of frictional engagement elements being selected and operated to set up a desired gear from a plurality of gears;
a hydraulic supply source;
a regulator valve for regulating line pressure on the basis of hydraulic pressure supplied from the hydraulic supply source, the line pressure becoming basis pressure for operating the frictional engagement elements;
a group of hydraulic control valves for carrying out supply control of engagement control hydraulic pressure to the frictional engagement elements, the group of hydraulic control valves including a plurality of linear solenoid valves capable of arbitrarily regulating shift control hydraulic pressure, a plurality of shift valves and a plurality of cut valves for carrying out selection of an oil passage so as to selectively supply the line pressure or the shift control hydraulic pressure regulated by any of the linear solenoid valves to the frictional engagement elements, and a plurality of On/Off solenoid valves for supplying operation control hydraulic pressure to the shift valves to control operations thereof;
hydraulic oil passages including a first hydraulic oil passage for supplying the shift control hydraulic pressure, supplied from a linear solenoid valve for setting up a low gear speed of the plurality of linear solenoid valves, to a low clutch that is one of the frictional engagement elements and a second hydraulic oil passage for supplying the line pressure regulated by the regulator valve to the low clutch, the first hydraulic oil passage and the second hydraulic oil passage being switched in accordance with an operation state and a set state of a predetermined shift valve of the plurality of shift valves, selection of the hydraulic oil passage being carried out by controlling operations of the plurality of shift valves in accordance with combination of On/Off operations of the plurality of On/Off solenoid valves, the same On/Off operation combination pattern of the plurality of On/Off solenoid valves being set up in each of an operation state and a set state of the plurality of cut valves to set up different gears;
lubricating oil passages extending toward the power transmission mechanism from the regulator valve to lubricate the power transmission mechanism, the lubricating oil passages including a first lubricating oil passage for supplying lubricating oil to the low clutch used to set up the low gear speed and a second lubricating oil passage for supplying lubricating oil with the line pressure to the low clutch, the second lubricating oil passage being selected by setting up the predetermined shift valve to the set state under a predetermined condition;
a check valve provided on the first lubricating oil passage, the check valve preventing the lubricating oil from flowing out from the frictional engagement elements other than the low clutch when the second lubricating oil passage is selected; and
an outflow preventing section provided on the second lubricating oil passage, the outflow preventing section preventing the lubricating oil, supplied to the low clutch via the first lubricating oil passage, from flowing out from any open port of the group of hydraulic control valves when the second lubricating oil passage is not selected.

2. The shift control device for the automatic transmission as claimed in claim 1, wherein the second lubricating oil passage is branched from the second hydraulic oil passage by the predetermined shift valve.

3. The shift control device for the automatic transmission as claimed in claim 1, wherein the outflow preventing section is a check valve for preventing the lubricating oil from flowing out, and
wherein, in the case where the predetermined condition is met at pseudo neutral control to set the automatic transmission to a pseudo neutral state even when a shift range of the automatic transmission is set to a drive range, the lubricating oil with the line pressure is supplied to the low clutch via the second lubricating oil passage.

4. The shift control device for the automatic transmission as claimed in claim 1, wherein the outflow preventing section is a lubricating oil switching valve for switching whether or not the lubricating oil is to be supplied, and
wherein, in the case where the predetermined condition is met at pseudo neutral control to set the automatic transmission to a pseudo neutral state even when a shift range of the automatic transmission is set to a drive range, the lubricating oil with the line pressure is supplied to the low clutch via the second lubricating oil passage by setting up the lubricating oil switching valve to a predetermined state.

5. The shift control device for the automatic transmission as claimed in claim 1, wherein the second lubricating oil passage is directly connected from the hydraulic supply source to the low clutch via a predetermined group of valves including the predetermined shift valve.
